(19) United States
(12) Patent Application Publication
(10) Pub. No.: US 2018/0132658 A1
(43) Pub. Date: May 17, 2018

(54) GRILL ROOF AND OUTDOOR COOKING INSTALLATION

(71) Applicant: I/P SOLUTIONS, INC., PERRYSBURG, OH (US)

(72) Inventor: JOSEPH L. YOUNG, TOLEDO, OH (US)

(73) Assignee: I/P SOLUTIONS, INC., PERRYSBURG, OH (US)

(21) Appl. No.: 15/573,230

(22) PCT Filed: May 12, 2016
(86) PCT No.: PCT/US16/31978

§ 371 Date: Nov. 10, 2017

Related U.S. Application Data
(60) Provisional application No. 62/160,667, filed on May 13, 2015.

(51) Int. Cl. A47J 37/07; E04H 15/36; E04H 15/58

(52) U.S. Cl. CPC A47J 37/0786; E04H 15/58; E04H 15/36

(57) ABSTRACT

A roof for use with an outdoor cooking appliance includes a A primary support assembly including a base and at least one support post, the base being coupled to the support post. A roof assembly includes a plurality of roof panels coupled to the at least one support post such that each is supported above the base. The roof panels are oriented such that the rear edge of one roof panel and the front edge of the adjacent roof panel overlap in at least a horizontal direction but are spaced apart to define an airflow passage therebetween. An outdoor cooking installation can be formed by mounting the roof over an outdoor cooking appliance.

### BACKGROUND OF THE INVENTION

Outdoor cooking appliances, such as gas grills, enable one to cook food in an outdoor setting. Many find such a setting enjoyable, as it allows participants to socialize in accommodating weather or to enjoy outdoor activities during cooking. Still yet, others prefer to cook outdoors to use cooking techniques such as grilling and smoking, that are hard to recreate in an indoor residential setting.

Outdoor cooking appliances typically include removable or hinged lids that facilitate indirect cooking and provide shelter for a cooking surface when not in use. Exposure to rain, for example, may hasten corrosion of components of an outdoor cooking appliance. Many outdoor cooking appliances include food preparation or storage areas adjacent a cooking surface. Such areas are typically exposed to weather and require cleaning before use to prevent contamination of food or utensils.

### SUMMARY OF THE INVENTION

The present invention is a roof for an outdoor cooking appliance that provides weather protection for the outdoor cooking appliance and a user thereof while minimizing interference of use of the outdoor cooking appliance.

A roof in accordance with the invention is provided for use with an outdoor cooking appliance. The roof comprises a primary support assembly including a base and at least one support post, the base being coupled to the support post. A roof assembly includes a plurality of roof panels, the roof panels being coupled to the at least one support post such that each is supported above the base. Each of the roof panels defines a front edge and a rear edge, with a first roof panel and a second roof panel being supported such that the rear edge of the first roof panel and the front edge of the second roof panel overlap in at least a horizontal direction but are spaced apart to define an airflow passage therebetween. An outdoor cooking installation can be formed by mounting the roof over an outdoor cooking appliance.

### BRIEF DESCRIPTION OF THE DRAWINGS

The advantages of the invention will become readily apparent to those skilled in the art from the following detailed description of various embodiments when considered in the light of the accompanying drawings, in which:

FIG. 1 is a perspective view of a roof for an outdoor cooking appliance in accordance with an embodiment of the invention;

FIG. 2 is an exploded perspective view of the roof of FIG. 1;

FIG. 3 is a side of the roof of FIG. 1 mounted on a pedestal;

FIG. 4 is a front view of the roof as shown in FIG. 3;

FIG. 5 is an enlarged view of portion A of FIG. 3; and

FIG. 6 is side view of an alternative embodiment of a roof for an outdoor cooking appliance in accordance with the invention.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts of the present invention. Hence, specific dimensions, directions, orientations or other physical characteristics relating to the embodiments disclosed are not to be considered as limiting, unless expressly stated otherwise.

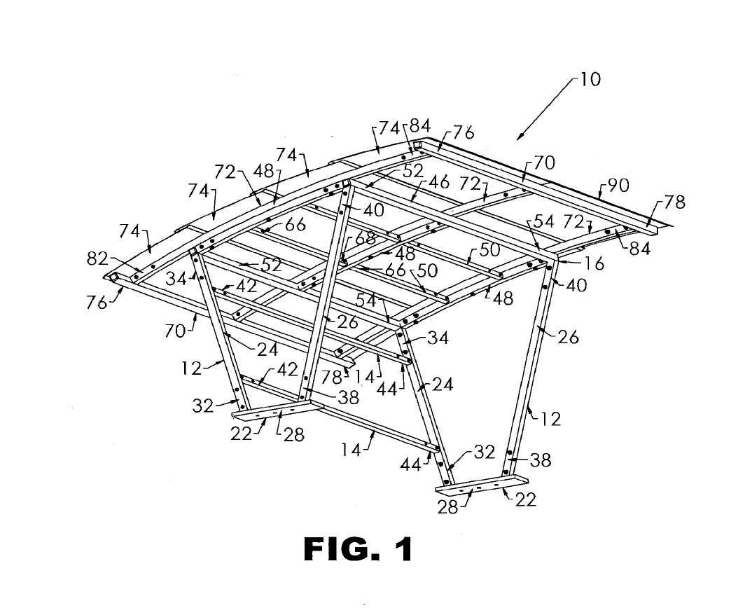

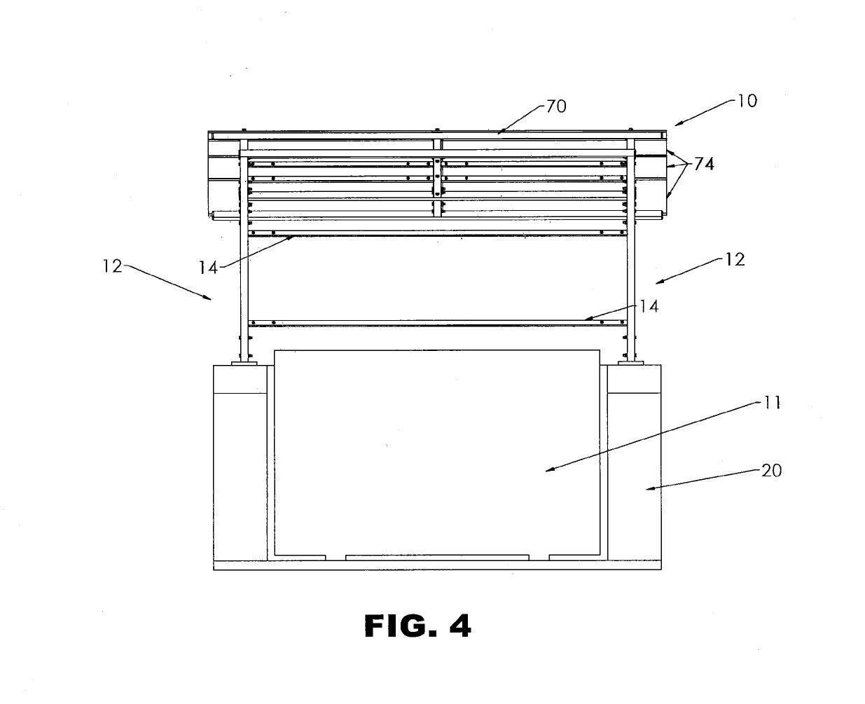

FIGS. 1-4 illustrate a roof 10 for use with an outdoor cooking appliance, such as the cooking appliance 11 shown schematically in FIG. 4. The roof 10 comprises a pair of primary support assemblies 12, a plurality of lateral supports 14, a lower roof subassembly 16, and an upper roof subassembly 18. The plurality of lateral supports 14 and the lower roof subassembly 16 are coupled to and extend between the primary support assemblies 12. The lower roof subassembly 16 is coupled to the primary support assemblies 12. The upper roof subassembly 18 is coupled to the lower roof subassembly 16.

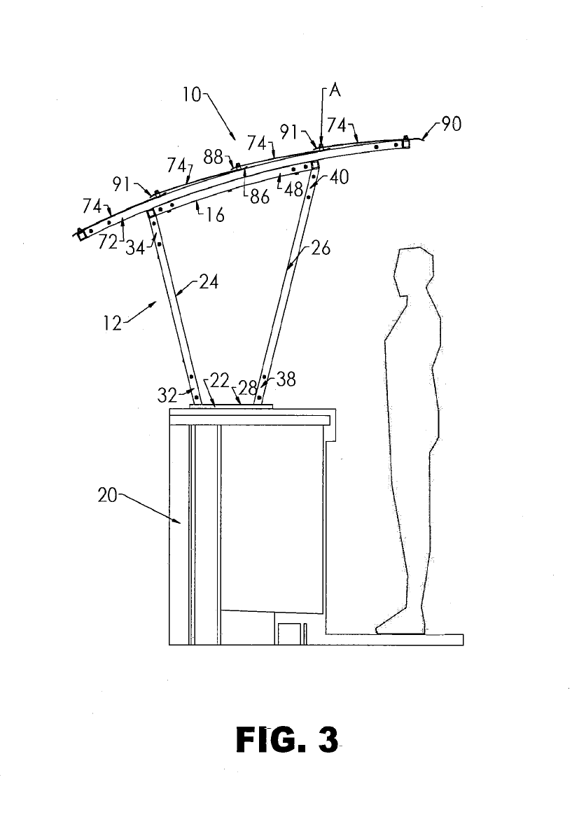

As shown in FIGS. 1-4, the roof 10 is coupled to a pedestal 20 (shown in FIG. 3). The outdoor cooking appliance 11 is positioned within the pedestal 20, underneath the upper roof subassembly 18. The roof 10 provides weather protection for the outdoor cooking appliance and a user thereof while minimizing interference of use of the outdoor cooking appliance.

With regards to the embodiment shown in FIGS. 1-4, the roof 10 comprises two primary support assemblies 12. Each of the primary support assemblies 12 includes a base, such as the base plate 22, a first support post 24, and a second support post 26. The first support post 24 and the second support post 26 are each coupled to the base plate 22 and the lower roof subassembly 16.

The base is a member mostly formed from a metal plate; however, it is understood that other rigid members of various shapes may form the base. The base plate 22 includes a main portion 28 and a pair of mounting posts 30. The main portion 28 is rectangular in shape and has a plurality of perforations formed therethrough for securing the base plate 22 (and thus the roof 10) to the pedestal 20. The pair of mounting posts 30 are opposingly disposed on the main portion 28 and are shown as oriented obliquely to the main portion 28; however, it is understood that the mounting posts 30 may be oriented perpendicularly to the main portion 28. Each of the mounting posts 30 is a metal tubular member which may be welded to the main portion 28; however, it is understood that the mounting posts 30 may be another rigid structure secured to the main portion 28 in any conventional manner.

The first support post 24 is a metal tubular member having a first end 32 and a second end 34. The first support post 24 has a square cross-section; however, it is understood that the first support post 24 may have other shapes. The first support post 24 receives one of the mounting posts 30 at the first end 32 thereof. The first support post 24 is coupled to the mounting post 30 using a fastener disposed through corresponding perforations formed through the first support post 24 and the mounting post 30; however, it is understood that the first support post 24 may be coupled to the mounting post 30 in any conventional manner. The first support post 24 receives a portion of the lower roof subassembly 16 at the second end 34 thereof. The first support post 24 is coupled to the portion of the lower roof subassembly 16 using a fastener disposed through corresponding perforations formed through the first support post 24 and the portion of the lower roof subassembly 16; however, it is understood that the first support post 24 may be coupled to the lower roof subassembly 16 in any conventional manner. The first support post 24 also includes two lateral posts 36 extending from a side thereof. The lateral posts 36 are oriented perpendicularly to the first support post 24; however, it is understood that the lateral posts 36 may be oriented in another manner. Each of the lateral posts 36 is a metal tubular member which may be welded to the first support post 24, intermediate of the first end 32 and the second end 34; however, it is understood that the lateral posts 36 may be another rigid structure secured to the first support post 24 in any conventional manner.

The second support post 26 is a metal tubular member having a first end 38 and a second end 40. The second support post 26 has a square cross-section; however, it is understood that the second support post 26 may have other shapes. The second support post 26 receives one of the mounting posts 30 at the first end 38 thereof. The second support post 26 is coupled to the mounting post 30 using a fastener disposed through corresponding perforations formed through the second support post 26 and the mounting post 30; however, it is understood that the second support post 26 may be coupled to the mounting post 30 in any conventional manner. The second support post 26 receives a portion of the lower roof subassembly 16 at the second end 40 thereof. The second support post 26 is coupled to the portion of the lower roof subassembly 16 using a fastener disposed through corresponding perforations formed through the second support post 26 and the portion of the lower roof subassembly 16; however, it is understood that the second support post 26 may be coupled to the lower roof subassembly 16 in any conventional manner.

The roof 10 comprises two lateral supports 14. Each of the lateral supports 14 is a metal tubular member having a first end 42 and a second end 44. Each of the lateral supports 14 has a square cross-section; however, it is understood that each of the lateral supports 14 may have other shapes. The lateral supports 14 receive the lateral posts 36 at both the first end 42 and the second end 44 thereof. Each of the lateral supports 14 is coupled to the lateral posts 36 using a fastener disposed through corresponding perforations formed through each of the lateral supports 14 and the lateral posts 36; however, it is understood that the lateral supports 14 may be coupled to the lateral posts 36 in any conventional manner.

The lower roof subassembly 16 comprises a pair of cross beams 46, a plurality of lower ribs 48, and a plurality of rib braces 50. Each of the lower ribs 48 is coupled to the cross beams 46. The plurality of rib braces 50 is disposed between the lower ribs 48 and is coupled thereto. The lower roof subassembly 16 is coupled to each of the primary support assemblies 12.

The cross beams 46 are metal tubular members each having a first end 52 and a second end 54. Each of the cross beams 46 has a square cross-section; however, it is understood that the cross beams 46 may have other shapes. The cross beams 46 each include a plurality of roof mounting posts 56 and a pair of support mounting posts 58 extending therefrom.

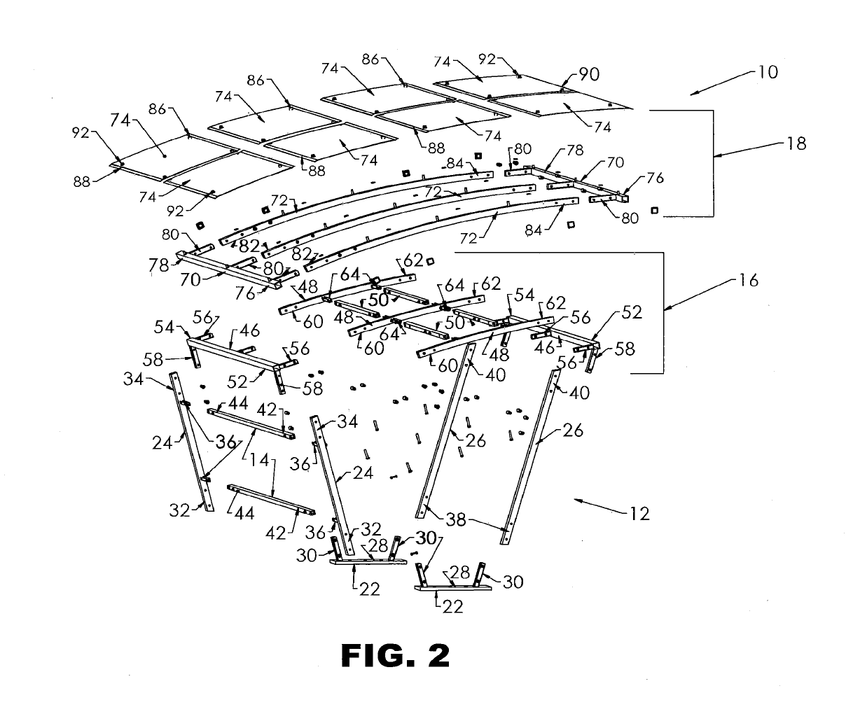

The plurality of roof mounting posts 56 are oriented perpendicularly to each of the cross beams 46; however, it is understood that the roof mounting posts 56 may be oriented in another manner. As most clearly shown in FIG. 2, each of the cross beams 46 includes three roof mounting posts 56; however, it is understood that each of the cross beams 46 may include another number of roof mounting posts 56. Each of the of roof mounting posts 56 is a metal tubular member which may be welded to each of the cross beams 46, at the first end 52, the second end 54, and intermediate the first end 52 and the second end 54; however, it is understood that the roof mounting posts 56 may be another rigid structure secured to each of the cross beams 46 in any conventional manner. The plurality of lower ribs 48 receives the roof mounting posts 56 at both a first end 60 and a second end 62 thereof. Each of the lower ribs 48 is coupled to the roof mounting posts 56 using a pair of fasteners disposed through corresponding perforations formed through each of the lower ribs 48 and the roof mounting posts 56; however, it is understood that the lower ribs 48 may be coupled to the roof mounting posts 56 in any conventional manner.

The plurality of support mounting posts 58 are oriented perpendicularly to the cross beams 46 and oriented one of perpendicularly and obliquely to the plurality of roof mounting posts 56; however, it is understood that the support mounting posts 58 may be oriented in another manner. As most clearly shown in FIG. 2, each of the cross beams 46 includes two support mounting posts 58. Each of the of support mounting posts 58 is a metal tubular member which may be welded to each of the cross beams 46, at the first end 52 and the second end 54; however, it is understood that support mounting posts 58 may be another rigid structure secured to each of the cross beams 46 in any conventional manner. Each of the first support posts 24 and each of the second support posts 26 receive the support mounting posts 58 at the second ends 34, 40 thereof. Each of the first support posts 24 is coupled to the support mounting posts 58 using a pair of fasteners disposed through corresponding perforations formed through each of the first support posts 24 and the support mounting posts 58; however, it is understood that the first support posts 24 may be coupled to the support mounting posts 58 in any conventional manner. Each of the second support posts 26 is coupled to the support mounting posts 58 using a pair of fasteners disposed through corresponding perforations formed through each of the second support posts 26 and the support mounting posts 58; however, it is understood that the second support posts 26 may be coupled to the support mounting posts 58 in any conventional manner.

Each of the plurality of lower ribs 48 is an arcuate, metal tubular member having the first end 60 and the second end 62. As most clearly shown in FIG. 2, the lower roof subassembly 16 comprises three lower ribs 48. The lower ribs 48 have a square cross-section; however, it is understood that the lower ribs 48 may have other shapes. The lower ribs 48 receive one of the roof mounting posts 56 at the first end 60 thereof and another one of the roof mounting posts 56 at the second end 62 thereof. The lower ribs 48 are coupled to the roof mounting posts 56 as described hereinabove. Each of the plurality of lower ribs 48 also includes at least one brace mounting post 64.

Each of the brace mounting posts 64 is oriented perpendicularly to the lower ribs 48; however, it is understood that the brace mounting posts 64 may be oriented in another manner. As most clearly shown in FIG. 2, two of the lower ribs 48 include two brace mounting posts 64 and one of the lower ribs 48 includes four brace mounting posts 64; however, it is understood that each of the lower ribs 48 may include another number of brace mounting posts 64. Each of the of brace mounting posts 64 is a metal tubular member which may be welded to each of the lower ribs 48, intermediate the first end 60 and the second end 62; however, it is understood that the brace mounting posts 64 may be another rigid structure secured to each of the lower ribs 48 in any conventional manner. The plurality of rib braces 50 receives the brace mounting posts 64 at both a first end 66 and a second end 68 thereof. Each of the rib braces 50 is coupled to the brace mounting posts 64 using a pair of fasteners disposed through corresponding perforations formed through each of the rib braces 50 and the brace mounting posts 64; however, it is understood that the rib braces 50 may be coupled to the brace mounting posts 64 in any conventional manner.

Each of the plurality of rib braces 50 is a metal tubular member having the first end 66 and the second end 68. As most clearly shown in FIG. 2, the lower roof subassembly 16 comprises four rib braces 50. The rib braces 50 have a square cross-section; however, it is understood that the rib braces 50 may have other shapes. The rib braces 50 receive one of the brace mounting posts 64 at the first end 66 thereof and another one of the brace mounting posts 64 at the second end 68 thereof. The rib braces 50 are coupled to the brace mounting posts 64 as described hereinabove.

The upper roof subassembly 18 comprises a pair of roof beams 70, a plurality of upper ribs 72, and a plurality of roof panels 74. Each of the upper ribs 72 is coupled to the roof beams 70. The plurality of roof panels 74 is disposed on the roof beams 70 and the upper ribs 72 and each of the roof panels 74 are coupled to at least one of the roof beams 70 and the upper ribs 72. The upper roof subassembly 18 is coupled to the lower roof subassembly 16 using a plurality of fasteners disposed through corresponding perforations formed in the lower ribs 48 and the upper ribs 72. The upper roof subassembly 18 extends over the lower roof subassembly 16, as most clearly seen in FIGS. 1 and 3.

The roof beams 70 are metal tubular members each having a first end 76 and a second end 78. Each of the roof beams 70 has a square cross-section; however, it is understood that the roof beams 70 may have other shapes. The roof beams 70 each include a plurality of roof mounting posts 80 extending therefrom.

The plurality of roof mounting posts 80 is oriented perpendicularly to the roof beams 70; however, it is understood that the roof mounting posts 80 may be oriented in another manner. As most clearly shown in FIG. 2, each of the roof beams 70 includes three roof mounting posts 80; however, it is understood that each of the roof beams 70 may include another number of roof mounting posts 80. Each of the of roof mounting posts 80 is a metal tubular member which may be welded to each of the roof beams 70, adjacent the first end 76, adjacent the second end 78, and intermediate the first end 76 and the second end 78; however, it is understood that the roof mounting posts 80 may be another rigid structure secured to each of the roof beams 70 in any conventional manner. A portion of the roof beams 70 extends beyond each of the roof mounting posts 80 adjacent the first end 76 and the second end 78, and thus the portion of the roof beams 70 also extend beyond the upper ribs 72. The plurality of upper ribs 72 receives the roof mounting posts 80 at both a first end 82 and a second end 84 thereof. Each of the upper ribs 72 is coupled to the roof mounting posts 80 using a pair of fasteners disposed through corresponding perforations formed through each of the upper ribs 72 and the roof mounting posts 80; however, it is understood that the upper ribs 72 may be coupled to the roof mounting posts 80 in any conventional manner.

Each of the plurality of upper ribs 72 is an arcuate, metal tubular member having the first end 82 and the second end 84. As most clearly shown in FIG. 2, the upper roof subassembly 18 comprises three upper ribs 72. The upper ribs 72 have a square cross-section; however, it is understood that the upper ribs 72 may have other shapes. The upper ribs 72 receive one of the roof mounting posts 80 at the first end 82 thereof and another one of the roof mounting posts 80 at the second end 84 thereof. The upper ribs 72 are coupled to the roof mounting posts 80 as described hereinabove. Each of the upper ribs 72 is coupled to a corresponding one of the lower ribs 48 using a fastener disposed through corresponding perforations formed through each of the upper ribs 72 and each of the lower ribs 48; however, it is understood that each of the upper ribs 72 may be coupled to the each of the lower ribs 48 in any conventional manner. Fastening of each of the upper ribs 72 to each of the lower ribs 48 also couples the upper roof subassembly 18 to the lower roof subassembly 16.

The plurality of roof panels 74 are disposed on and coupled to the roof beams 70 and the upper ribs 72. As most clearly shown in FIG. 2, in the illustrated embodiment, the plurality of roof panels 74 comprises eight roof panels 74. Each of the roof panels 74 is preferably a sheet of material that is rectangular in shape, and is preferably formed of sheet metal, most preferably powder-coated steel or stainless steel. As will be appreciated, the side-by-side pairs of panels 74 shown in FIG. 2 essentially form four roof panels, and each pair of “roof panels” could be formed of a single unitary sheet. The roof of the invention includes at least two, and more preferably at least three, such roof panels.

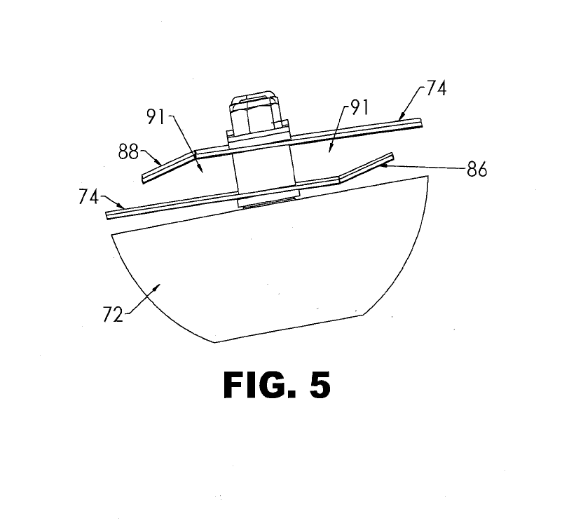

An arcuate shape of each of the roof panels 74 corresponds to the arcuate shape of each of the upper ribs 72. Each of the roof panels 74 includes a front edge 86 and a rear edge 88. Six of the roof panels 74 include an area adjacent the rear edge 88 to be bent in a slightly downward direction and an area adjacent the front edge 86 to be bent in a slightly upward direction, as best seen in FIG. 5. A remaining two roof panels 74, which are disposed over a front edge 90 of the upper roof assembly 18, include both areas adjacent the rear edge 88 and the front edge 86 to be bent in a slightly downward direction. Such an orientation of the areas adjacent the rear edge 88 and the front edge 86 increase a wind resilience of the upper roof subassembly 18, and thus the roof 10. The areas between the rear edge 88 and the front edge 86 define a plurality of airflow passages 91. Each of the roof panels 74 is preferably configured to support a load of at least about 30 pounds per square inch. Such a load could result from, for example, an accumulation of frozen precipitation.

The airflow passages 91 increase the wind resilience of the roof 10 by allowing air to pass through the airflow passages 91, directing a portion of a force effected by the moving air from a downward facing side of each of the roof panels 74 to an upward facing side of an adjacent roof panel 74. Air passing through the airflow passages 91 pushes the roof 10 in a generally downward direction as the moving air is deflected over the upward facing side of each of the panels 74. The airflow passages 91 substantially reduce the roof 10 from generating lift force on the downward facing side of the roof panels 74. The airflow passages 91 may facilitate wind resistance of the roof 10 up to a wind speed of about 120 miles per hour.

Alternately, it is understood that the roof 10 may be configured with hinged panels (not shown) configured to open in response to a differential in air pressure between the downward facing side of and the upward facing side of the roof panels 74. Such hinged panels could be biased into a closed position through the use of a biasing member, such as a coil spring, for example. In response to a differential in air pressure between the downward facing side of and the upward facing side of the roof panels 74, the hinged panels would open to prevent the roof 10 from generating a lift force on the downward facing side of the roof panels 74.

The orientation of the areas adjacent the rear edge 88 and the front edge 86 also facilitate draining of water from the upper roof subassembly 18 and prevent water from draining between adjacent panels 74. Water drains from the upward facing side of the roof panels 74 by flowing in a direction towards the second end 34 of each of the first support posts 24 and then dripping from the rear edge 88 of the roof panels 74 adjacent thereto. Perforations 92 are formed adjacent each corner of each of the roof panels 74. Each of the roof panels 74 is coupled to the roof beams 70 and/or the upper ribs 72 using a fastener disposed through the perforations 92 and a corresponding perforation formed through the roof beams 70 and the upper ribs 72; however, it is understood that each of the roof panels 74 may be coupled to the roof beams 70 and the upper ribs 72 in any conventional manner.

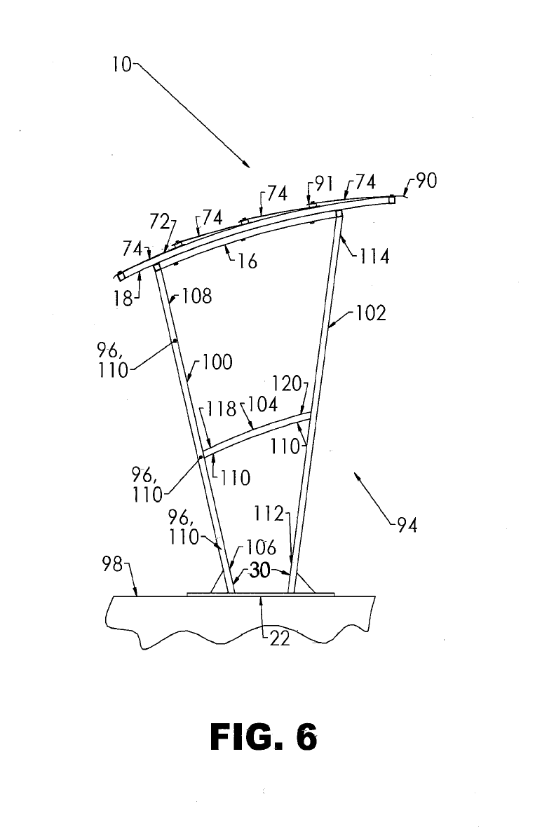

FIG. 6 illustrates the roof 10′ according to another embodiment of the invention. The embodiment shown in FIG. 6 includes similar components to the roof 10 illustrated in FIGS. 1-4. Similar structural features of the roof 10′ include the same reference numeral and a prime (′) symbol, with the exception of the features described below.

FIG. 6 illustrates the roof 10′ for use with an outdoor cooking appliance (not shown). The roof 10′ comprises a pair of primary support assemblies 94, a plurality of lateral supports 96, a lower roof subassembly 16′, and an upper roof subassembly 18′. The plurality of lateral supports 96 and the lower roof subassembly 16′ are coupled to and extend between the primary support assemblies 94. The lower roof subassembly 16′ is coupled to the primary support assemblies 94. The upper roof subassembly 18′ is coupled to the lower roof subassembly 16′. In the embodiment shown in FIG. 6, the roof 10′ is coupled to a mounting surface 98 (shown in FIG. 4). The outdoor cooking appliance is positioned on the mounting surface 98, underneath the upper roof subassembly 18′. The roof 10′ provides weather protection for the outdoor cooking appliance and a user thereof while minimizing interference of use of the outdoor cooking appliance.

As shown in FIG. 6, the roof 10′ comprises two primary support assemblies 94. Each of the primary support assemblies 94 includes a base plate 22′, a first support post 100, a second support post 102, and at least one cross-support 104. The first support post 100 and the second support post 102 are each coupled to the base plate 22′ and the lower roof subassembly 16′. FIG. 6 illustrates the roof 10′ including one cross-support 104, disposed between and coupled to the first support post 100 and the second support post 102; however, it is understood that the roof 10′ may include more than one cross-support 104.

The first support post 100 is a metal tubular member having a first end 106 and a second end 108. The first support post 100 has a square cross-section; however, it is understood that the first support post 100 may have other shapes. The first support post 100 receives a mounting post 30′ at the first end 106 thereof. The first support post 100 is coupled to the mounting post 30′ using a fastener disposed through corresponding perforations formed through the first support post 100 and the mounting post 30′; however, it is understood that the first support post 100 may be coupled to the mounting post 30′ in any conventional manner. The first support post 100 receives a portion of the lower roof subassembly 16′ at the second end 108 thereof. The first support post 100 is coupled to the portion of the lower roof subassembly 16′ using a fastener disposed through corresponding perforations formed through the first support post 100 and the portion of the lower roof subassembly 16′; however, it is understood that the first support post 100 may be coupled to the lower roof subassembly 16′ in any conventional manner. The first support post 100 also includes four lateral posts 110 extending from two sides thereof. Three of the lateral posts 110 are oriented perpendicularly to the first support post 100 on a first side of the first support post 100, and a remaining one of the lateral posts 110 is oriented obliquely to the first support post 100 on a second side of the first support post 100; however, it is understood that the lateral posts 110 may be oriented in another manner. Each of the lateral posts 110 is a metal tubular member which may be welded to the first support post 100, intermediate of the first end 106 and the second end 108; however, it is understood that the lateral posts 110 may be another rigid structure secured to the first support post 100 in any conventional manner.

The second support post 102 is a metal tubular member having a first end 112 and a second end 114. The second support post 102 has a square cross-section; however, it is understood that the second support post 102 may have other shapes. The second support post 102 receives one of the mounting posts 30′ at the first end 112 thereof. The second support post 102 is coupled to the mounting post 30′ using a fastener disposed through corresponding perforations formed through the second support post 102 and the mounting post 30′; however, it is understood that the second support post 102 may be coupled to the mounting post 30′ in any conventional manner. The second support post 102 receives a portion of the lower roof subassembly 16′ at the second end 114 thereof. The second support post 102 is coupled to the portion of the lower roof subassembly 16′ using a fastener disposed through corresponding perforations formed through the second support post 102 and the portion of the lower roof subassembly 16′; however, it is understood that the second support post 102 may be coupled to the lower roof subassembly 16′ in any conventional manner. The second support post 102 also includes one lateral post 116 extending from a side thereof. The lateral post 116 is oriented obliquely to the second support post 102; however, it is understood that the lateral post 116 may be oriented in another manner. The lateral post 116 is a metal tubular member which may be welded to the second support post 102, intermediate of the first end 112 and the second end 114; however, it is understood that the lateral post 116 may be another rigid structure secured to the second support post 102 in any conventional manner.

The roof 10′ comprises three lateral supports 96. Each of the lateral supports 96 is a metal tubular member having a first end and a second end. Each of the lateral supports 96 has a square cross-section; however, it is understood that each of the lateral supports 96 may have other shapes. The lateral supports 96 receive the lateral posts 110 at both the first end and the second end thereof. Each of the lateral supports 96 is coupled to the lateral posts 110 using a fastener disposed through corresponding perforations formed through each of the lateral supports 96 and the lateral posts 110; however, it is understood that the lateral supports 96 may be coupled to the lateral posts 110 in any conventional manner.

Each of the primary support assemblies 94 comprises a cross-support 104. The cross-support 104 is a metal tubular member having a first end 118 and a second end 120. The cross-support 104 has a square cross-section; however, it is understood that the cross-support 104 may have other shapes. The cross-support 104 receives one of the lateral posts 110 of the first support post 100 at the first end 118 and one of the lateral posts 116 of the second support post 102 at the second end 120 thereof. The cross-support 104 is coupled to the lateral posts 110, 116 using a fastener disposed through corresponding perforations formed through the cross-support 104 and the lateral posts 110, 116; however, it is understood that the cross-support 104 may be coupled to the lateral posts 110, 116 in any conventional manner.

The mounting surface 98 is a rigid surface to which the roof 10′ is mounted to through the base plates 22′. The mounting surface 98 and each of the base plates 22′ are configured to accept a plurality of fasteners to couple the roof 10′ thereto. As non-limiting examples, the mounting surface 98 may be a portion of a deck, a patio, or a concrete surface.

In accordance with the provisions of the patent statutes, the present invention has been described in what is considered to represent its preferred embodiments, however, it should be noted that the invention can be practiced otherwise than as specifically illustrated and described without departing from its scope or spirit.

What is claimed is:

1. A roof for use with an outdoor cooking appliance, comprising:
a primary support assembly including a base and at least one support post, the base being coupled to the support post; and
a roof assembly including a plurality of roof panels, the roof panels being coupled to the at least one support post such that each is supported above the base,
wherein each of the roof panels defines a front edge and a rear edge, with a first roof panel and a second roof panel being supported such that the rear edge of the first roof panel and the front edge of the second roof panel overlap in at least a horizontal direction but are spaced apart to define an airflow passage therebetween.

2. The roof of claim 1, wherein each of the roof panels is supported above the base such that the roof panel angles downwardly from the front edge to the rear edge thereof.

3. The roof of claim 1, wherein proximate an area where the first and second roof panels overlap in a horizontal direction, the rear edge of the first roof panel bends downwardly toward the second roof panel and the front edge of second roof panel bends upwardly toward the first roof panel.

4. The roof of claim 3, wherein the front edge of the first roof panel bends downwardly.

5. The roof of claim 1, wherein the roof assembly comprises three or more roof panels.

6. The roof of claim 5, wherein each of the roof panels is supported above the base such that the roof panel angles downwardly from the front edge to the rear edge thereof.

7. The roof of claim 1, wherein the primary support assembly defines a first primary support assembly, and the roof further comprises a second primary support assembly spaced apart from the first primary support assembly, the second primary support assembly including a base and at least one support post, the base being coupled to the support post, with the first and second roof panels being coupled to the at least one support post of the second primary support assembly such that each roof panel is supported above the base of the second primary support assembly.

8. The roof of claim 1, further comprising a plurality of rib members, wherein the first and second roof panels are coupled to the plurality of rib members, which are in turn coupled to the at least one support post.

9. The roof according to claim 8, wherein each of the plurality of rib members is an arcuate member.

10. The roof of claim 1, wherein the primary support assembly includes two support posts, each extending obliquely from the base.

11. An outdoor cooking installation comprising the roof of claim 1 mounted over an outdoor cooking appliance.

12. An outdoor cooking installation comprising the roof of claim 7 mounted over an outdoor cooking appliance, wherein the outdoor cooking appliance is positioned between the first and second primary support assemblies.
